(19) United States
(12) Patent Application Publication
(10) Pub. No.: US 2007/0019450 A1
(43) Pub. Date: Jan. 25, 2007

(54) System and method for regulating an output of a switching supply circuit

(75) Inventors: Kee-Chee Tiew, Richardson, TX (US); Jingwei Xu, Shanghai (CN); Brett Smith, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/180,755

(22) Filed: Jul. 13, 2005

(51) Int. Cl. H02M 3/24

(52) U.S. Cl. 363/98

(57) ABSTRACT

A system and method is provided for regulating an output current in a switching supply circuit. In one embodiment, a switching supply circuit comprises a high-side field-effect transistor (FET), a low-side FET, and a driver control circuit operative to switch the high-side FET and the low-side FET between opposing “ON” and “OFF” states. The system further comprises a simulated output generator that is operative to combine both a first output waveform associated with the high-side FET and a second output waveform associated with the low-side FET to generate a simulated output signal that is a substantial representation of an output signal of the switching supply circuit, the simulated output signal being provided as a feedback to the driver control circuit.

### TECHNICAL FIELD

This invention relates to electronic circuits, and more specifically to a system and method for regulating an output of a switching supply circuit.

### BACKGROUND

Switching regulators have been implemented as an efficient mechanism for providing a regulated output in power supplies. One such type of regulator is known as a switching supply circuit, which controls the flow of power to a load by controlling the “ON” and “OFF” duty-cycle of one or more high-side switches coupled to the load. Many different classes of switching supplies exist today. One type of switching supply circuit is known as a synchronous switching supply circuit. In a synchronous switching supply circuit, an inductor is used to maintain current flow that is switched from two separate sources. The two sources can include a high-side switch, such as a high-side field-effect transistor (FET), and a low-side switch, such as a low-side FET. After the high-side FET is deactivated, the low side FET becomes activated. The low side FET thus conducts current from ground to the inductor because magnetic power stored in the inductor dissipates to force current through the inductor by changing the voltage of the inductor source node to negative relative to ground. In this way, current continuously flows through the inductor, even at times when the high-side switch is deactivated.

It is desirable in the design of switching supplies to ensure that the output of the switching supply circuit is properly regulated. For example, if a load at the output of the switching supply circuit changes, it may be necessary to change the switching operation, such as by adjusting the switching duty cycle, to regulate the output voltage to a relatively constant level. Regulation is typically accomplished through feedback control, by either a voltage feedback technique, in which the output voltage of the switching supply is monitored, or a current feedback technique, in which both the output voltage and the inductor current are monitored. The current feedback technique can monitor the inductor current by connecting a current sense resistor in series with the output inductor. However, a resistor connected in series with the output inductor can result in a degradation of the performance efficiency of the switching supply circuit. Another way to accomplish the current feedback technique is by measuring a current flow through the high-side FET. However, this measurement control may result in inaccurate regulation because the feedback is based only on the high-side current information.

### SUMMARY

In one embodiment of the present invention, a switching supply circuit comprises a high-side field-effect transistor (FET), a low-side FET, and a driver control circuit operative to switch the high-side FET and the low-side FET between opposing “ON” and “OFF” states. The system further comprises a simulated output generator that is operative to combine both a first output waveform associated with the high-side FET and a second output waveform associated with the low-side FET to generate a simulated output signal that is a substantial representation of an output signal of the switching supply circuit, the simulated output signal being provided as a feedback to the driver control circuit.

In another embodiment of the present invention, a method for regulating an output current in a switching supply circuit comprises measuring a first output waveform associated with a high-side FET, measuring a second output waveform associated with a low-side FET, and combining the first output waveform and the second output waveform to generate a combined output waveform. The method further comprises generating a simulated output signal based on the combined output waveform, the simulated output signal being a substantial representation of the output current of the switching supply circuit, and providing the simulated output signal as a feedback to a driver control circuit.

In yet another embodiment of the present invention, a switching supply circuit comprises means for a measuring a first output signal associated with a high-side FET, means for a measuring a second output signal associated with a low-side FET, and means for combining the first output signal and the second output signal to generate a simulated output signal. The simulated output signal is a substantial representation of the output of the switching supply circuit. The switching supply circuit further comprises means for regulating the output of the switching supply circuit based on the simulated output signal.

### BRIEF DESCRIPTION OF THE DRAWINGS

FIG. 1 illustrates a switching supply circuit with output regulation feedback in accordance with an aspect of the invention.

FIG. 2 illustrates another switching supply circuit with output regulation feedback in accordance with an aspect of the invention.

FIG. 3 illustrates waveforms that are generated to regulate a switching supply circuit in accordance with an aspect of the invention.

FIG. 4 illustrates a method for regulating an output of a switching supply circuit in accordance with an aspect of the invention.

### DETAILED DESCRIPTION

The present invention relates to electronic circuits, and more specifically to a system and method for regulating an output of a switching supply circuit. In a switching supply circuit, an output waveform (e.g., voltage waveform, current waveform) is measured through each of a high-side field effect transistor (FET) and a low-side FET. The output waveforms are combined to generate a combined output waveform. The combined output waveform is input to a track-and-hold circuit that removes switching gaps from the combined output waveform. The resulting combined output waveform can be input to a simulated output generator to generate a simulated output signal. The simulated output signal is a substantial representation of the output current of the switching supply circuit. The simulated output signal is a feedback signal that is input to a driver control circuit for the switching supply circuit. The driver control circuit can thus use the feedback from the simulated output signal to regulate the output of the switching supply circuit.

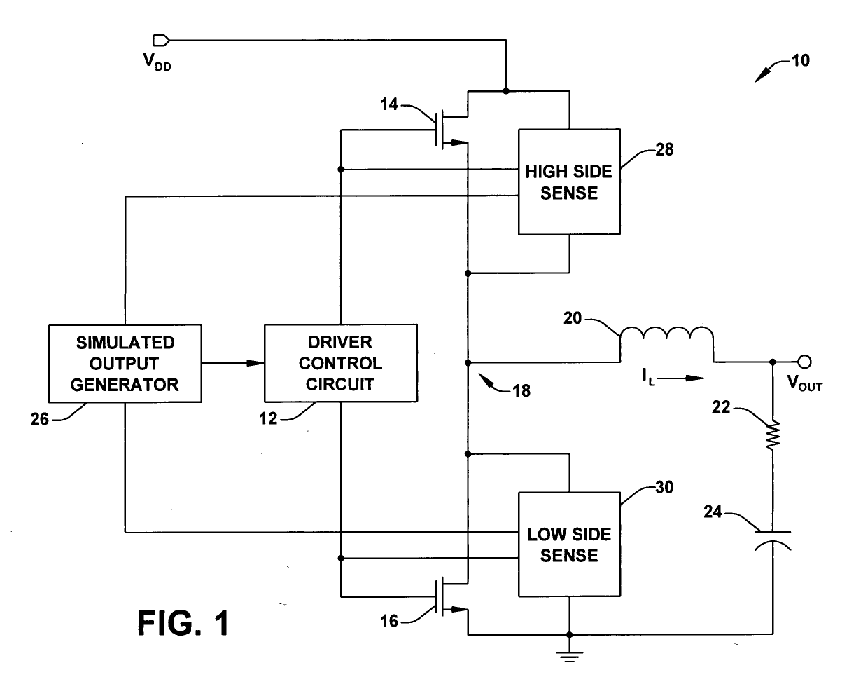

FIG. 1 demonstrates a switching supply circuit 10 in accordance with an aspect of the present invention. The switching supply circuit 10 could be, for example, a synchronous buck or a synchronous boost converter, and could be a self-oscillating or a fixed-frequency pulse-width modulation regulator. The switching supply circuit 10 includes a driver control circuit 12 that controls the operation of a high-side FET 14 and a low-side FET 16. The high-side FET 14 and the low-side FET 16 are demonstrated in the example of FIG. 1 as N-type FETs. However, other types of transistors could be used in accordance with an aspect of the invention. The high-side FET 14 is interconnected between a positive voltage rail V_{DD} at a drain terminal and a switching node 18 at a source terminal. The low-side FET 16 is interconnected between the switching node 18 at a drain terminal and a negative voltage rail at a source terminal, the negative voltage rail being demonstrated as ground in the example of FIG. 1. The driver control circuit 12 thus controls the voltage potential at the switching node 18 by switching between opposing “ON” and “OFF” states of the high-side FET 14 and the low-side FET 16. It is to be understood that the opposing switching of the high-side FET 14 and of the low side FET 16 is such that only one of the high-side FET 14 and the low side FET 16 may be activated at a given time to avoid a short circuit between the positive rail V_{DD} and ground. As such, the driver control circuit introduces switching gaps between alternate activation of the high-side FET 14 and the low-side FET 16.

The switching supply circuit 10 also includes an output inductor 20. The output inductor 20 is interconnected between the switching node 18 and the output V_{OUT} of the switching supply circuit 10, the output V_{OUT} being coupled to ground by a series connected resistor 22 and capacitor 24. The output inductor 20 maintains a relatively constant current I_{L} flowing to the output of the switching supply circuit 10, as described above. Because the load at the output of the switching supply circuit 10 may change in response to the operation of other circuit components to which the switching supply circuit 10 is supplying power, the output of the switching supply circuit 10 may need to be regulated to maintain relatively constant values of the output current I_{L}, as well as the corresponding output voltage V_{OUT}. Accordingly, the switching supply circuit 10 includes a simulated output generator 26 that supplies feedback to the driver control circuit 12, the feedback being a simulated output signal that is a substantial representation of the output current I_{L}.

The simulated output generator 26 receives inputs from a high-side sense circuit 28 and a low-side sense circuit 30. The high-side sense circuit 28, upon activation of the high-side FET 14, measures a first output waveform of the high-side FET 14, which could be a voltage potential across a sense resistor connected in parallel with the high-side FET 14. The first output waveform is output from the high-side sense circuit 28 to the simulated output generator 26. The low-side sense circuit 30, upon activation of the low-side FET 16, measures a second output waveform of the low-side FET 16, which could be a voltage potential across a sense resistor connected in parallel with the low-side FET 16. The second output waveform is output from the low-side sense circuit 30 to the simulated output generator 26.

The simulated output generator 26 combines the first output waveform and the second output waveform, such as through an analog multiplexer, to generate a combined output waveform. The combined output waveform may have signal conditioning performed on it, such as by removing switching gaps inherent through the alternating activation of the high-side FET 14 and the low-side FET 16. The resultant signal is the simulated output signal that is a substantial representation of the output current I_{L}. The simulated output signal could be a current signal, such that it is a simulated output current signal that is a substantial reproduction of the inductor output current I_{L}. Alternatively, the simulated output signal could be a voltage waveform that corresponds approximately to the output current I_{L}. The driver control circuit 12 receives the simulated output signal as feedback for the purpose of regulating the output current I_{L} through the inductor 20, for example, by controlling the amount of time (e.g., duty cycle) that the high-side FET 14 is “ON” relative to the low-side FET 16. It is to be understood that the driver control circuit 12 could receive feedback in the form of both a simulated output signal and a separate output voltage signal, such as in the above described current feedback technique, for the purpose of regulating the output current I_{L} through the inductor 20.

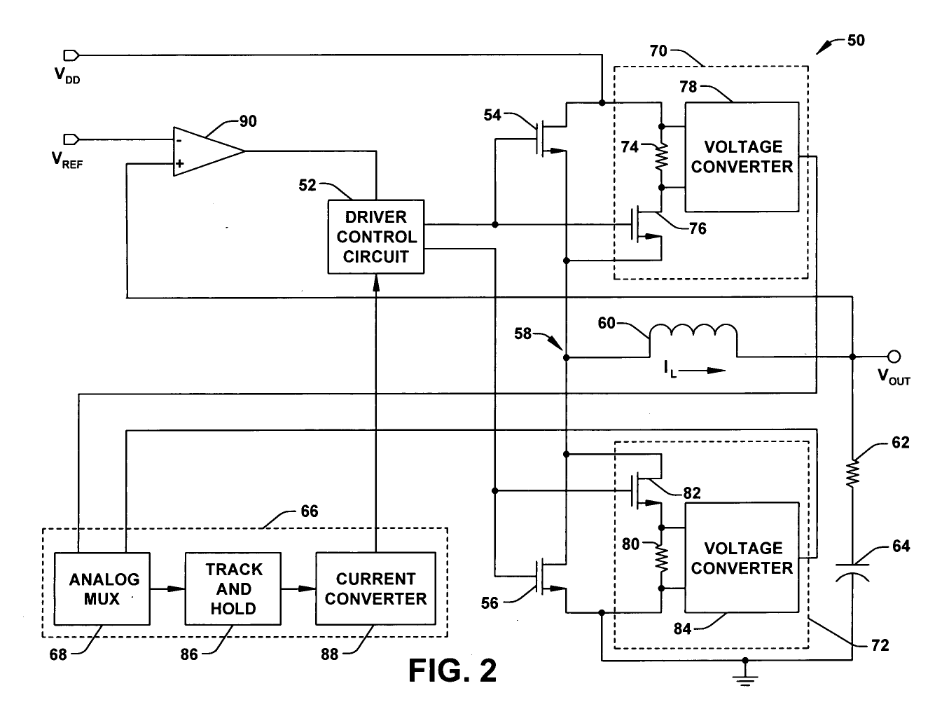

FIG. 2 demonstrates another example of a switching supply circuit 50 in accordance with an aspect of the present invention. The switching supply circuit 50 could be, for example, a synchronous buck converter. The switching supply circuit 50 includes a driver control circuit 52 that controls the operation of a high-side FET 54 and a low-side FET 56. The high-side FET 54 and the low-side FET 56 are demonstrated in the example of FIG. 1 as N-type FETs. However, other types of transistors could be used in accordance with an aspect of the invention. The high-side FET 54 is interconnected between a positive voltage rail V_{DD} at a drain terminal and a switching node 58 at a source terminal. The low-side FET 56 is interconnected between the switching node 58 at a drain terminal and a negative voltage rail, demonstrated as ground in the example of FIG. 1, at a source terminal. The driver control circuit 52 thus controls the voltage potential at the switching node 58 by switching between opposing “ON” and “OFF” states of the high-side FET 54 and the low-side FET 56. As described above regarding FIG. 1, the driver control circuit introduces switching gaps between alternate activation of the high-side FET 54 and the low-side FET 56.

The switching supply circuit 50 also includes an output inductor 60. The output inductor 60 is interconnected between the switching node 58 and the output V_{OUT} of the switching supply circuit 50, the output V_{OUT} being coupled to ground by a series connected resistor 62 and capacitor 64. The output inductor 60 maintains a relatively constant current I_{L} flowing to the output of the switching supply circuit 50. To regulate the output based on various applied loads, the switching supply circuit 50 includes a simulated output generator 66 that supplies feedback to the driver control circuit 52, the feedback being a simulated output signal that is a substantial representation of the output current I_{L}.

The simulated output generator 66 includes an analog multiplexer 68 that receives an input from each of a high-side sense circuit 70 and a low-side sense circuit 72. The high-side sense circuit 70 includes a sense resistor 74, a sense FET 76, and a voltage converter circuit 78. The sense resistor 74 and the sense FET 76 are connected in series with each other, with the series connection of the sense resistor 74 and the sense FET 76 being connected in parallel with the high-side FET 54. The voltage converter circuit 78 is connected in parallel with the sense resistor 74. The sense FET 76 has a gate terminal that is connected to a gate terminal of the high-side FET 54, such that the driver control circuit 52 activates both the high-side FET 54 and the sense FET 76 concurrently. As the sense FET 76 is not used to supply power to the switching node 58, the sense FET 76 may be substantially smaller in size than the high-side FET 54. The sense FET 76 could also be matched to the high-side FET 54, such that the sense FET 76 and the high-side FET 54 have substantially the same electrical characteristics, and such that the sense FET 76 is a scaled down version of the high-side FET 54.

Upon activation of the high-side FET 54, the sense FET 76 also becomes activated and current flows through the sense resistor 74. The current flow through the sense resistor 74 is a significantly scaled down equivalent to the current flow through the high-side FET 54. The current flow through the sense resistor 74 is thus measured and converted to a high-side voltage waveform by the voltage converter 78 (e.g., a differential amplifier), the voltage waveform being associated with the current flow through the high-side FET 54 over time.

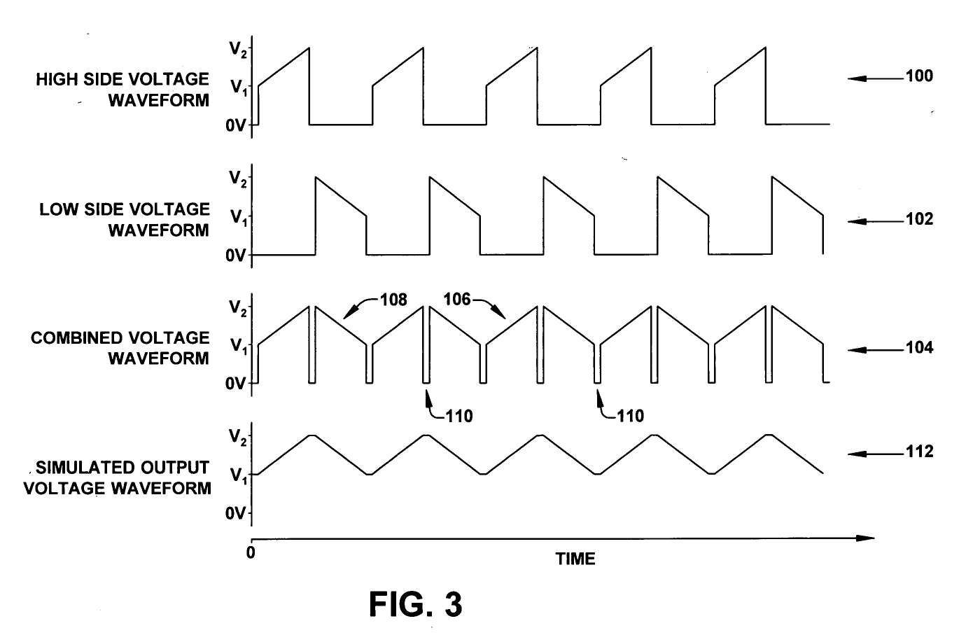

FIG. 3 demonstrates a high-side voltage waveform 100 in accordance with an aspect of the invention. At each activation of the high-side FET 54, the voltage increases rapidly from 0 volts to a voltage V₁. While the high-side FET 54 is activated, the slope of the voltage of the high-side voltage waveform 100 gradually increases from the voltage V₁ to a voltage V₂. This is because the high-side FET 54 is connecting the switching node 58 to the positive voltage rail V_{DD}. When the high-side voltage waveform 100 reaches the voltage V₂, the high-side FET 54 becomes deactivated, and the voltage of the high side FET 100 rapidly decreases from the voltage V₂ to 0 volts. The period of the high-side voltage waveform 100 is thus repeated at every activation of the high-side FET 54. The high-side voltage waveform 100 is output from the voltage converter 78 to the analog multiplexer 68. It is to be understood that, in the activation and deactivation of the high-side FET 54, the example of FIG. 3 illustrates that the voltage in the high-side voltage waveform 100 has an infinite positive and negative slope. However, this is for exemplary purposes merely to demonstrate very rapid changes in the slope of the voltage at the activation and deactivation of the high-side FET 54.

Referring back to FIG. 2, the low-side sense circuit 72 includes a sense resistor 80, a sense FET 82, and a voltage converter circuit 84. The sense resistor 80 and the sense FET 82 are connected in series with each other, with the series connection of the sense resistor 80 and the sense FET 82 being connected in parallel with the low-side FET 56. The voltage converter circuit 84 is connected in parallel with the sense resistor 80. The sense FET 82 has a gate terminal that is connected to a gate terminal of the low-side FET 56, such that the driver control circuit 52 activates both the low-side FET 56 and the sense FET 82 concurrently. As the sense FET 82 is not used to supply power to the switching node 58, the sense FET 82 may be substantially smaller in size than the low-side FET 56. The sense FET 82 could also be matched to the low-side FET 56, such that the sense FET 82 and the low-side FET 56 have substantially the same electrical characteristics, and such that the sense FET 82 is a scaled down version of the low-side FET 54. The ratio of the size of the sense FET 82 and the low-side FET 56 can be substantially the same as the ratio of the size of the sense FET 76 and the high-side FET 54. Additionally, the sense FET 76 and the sense FET 82 can be matched FETs, such that they have substantially the same electrical characteristics.

Upon activation of the low-side FET 56, the sense FET 82 also becomes activated and current flows through the sense resistor 80. The current flow through the sense resistor 80 is a significantly scaled down equivalent to the current flow through the low-side FET 56. The current flow through the sense resistor 80 is thus measured and converted to a low-side voltage waveform by the voltage converter 84 (e.g., a differential amplifier), the voltage waveform being associated with the current flow through the low-side FET 56 over time.

FIG. 3 demonstrates the low-side voltage waveform 102 in accordance with an aspect of the invention. At each activation of the low-side FET 56, the voltage increases rapidly from 0 volts to a voltage V₂. While the low-side FET 56 is activated, the slope of the voltage of the low-side voltage waveform 102 gradually decreases from the voltage V₂ to a voltage V₁. This is because the low-side FET 56 is connecting the switching node 58 to ground. When the low-side voltage waveform 102 reaches the voltage V₁, the low-side FET 56 becomes deactivated, and the voltage rapidly decreases from the voltage V₁ to 0 volts. The period of the low-side voltage waveform 102 is thus repeated at every activation of the low-side FET 56. The low-side voltage waveform 102 is output from the voltage converter 84 to the analog multiplexer 68. It is to be understood that, in the activation and deactivation of the low-side FET 56, the example of FIG. 3 illustrates that the voltage in the low-side voltage waveform 102 has an infinite positive and negative slope. However, this is for exemplary purposes merely to demonstrate very rapid changes in the slope of the voltage at the activation and deactivation of the low-side FET 56.

Referring back to FIG. 2, the analog multiplexer 68 in the simulated output generator 66 combines the high-side voltage waveform 100 and the low-side voltage waveform 102 to generate a combined voltage waveform. FIG. 3 demonstrates the combined voltage waveform 104 having a high-side portion 106 and a low-side portion 108. The combined voltage waveform 104 is a signal that is essentially created from the alternate switching of the high-side FET 54 and the low-side FET 56. As described above, the activation of the high-side FET 54 and the activation of the low side FET 56 are mutually exclusive events. Accordingly, the combined voltage waveform 104 includes a number of switching gaps 110 between each of the alternate activation of the high-side FET 54 and the low-side FET 56.

Referring back to FIG. 2, the combined voltage waveform 104 is input to a track-and-hold circuit 86 within the simulated output generator 66. The track-and-hold circuit 86 tracks the combined voltage waveform 104 by passing only gradual changes in slope. Rapid changes in slope of the combined voltage waveform 104, such as at the switching gaps 110, are held at a constant level. The resultant signal is a simulated output voltage signal 112, as demonstrated in FIG. 3. The simulated output voltage signal 112 is a voltage signal that is essentially composed of the combination of the high-side voltage waveform 100 and the low-side voltage waveform 102 without the switching gaps 110, such that it is substantially a sawtooth waveform that alternates between the voltage V₁ and the voltage V₂. The simulated output voltage waveform 112 is therefore a substantial representation of the output of the switching supply circuit 50, as it is a voltage waveform that corresponds approximately to the output current I_{L}.

Referring back to FIG. 2, the simulated output voltage signal 112 could be input to a current converter circuit 88, such that the simulated output voltage signal 112 is converted into a simulated output current signal that is a substantial representation of the output current I_{L}. The simulated output signal that is output from the current converter circuit 88 is input as a feedback signal to the driver control circuit 52, such that the driver control circuit 52 utilizes the feedback simulated output current signal to regulate the output current I_{L}. Alternatively, the driver control circuit 52 could receive the simulated output voltage signal 112 directly as a feedback signal to regulate the output current I_{L}, without converting the simulated output voltage signal 112 into a current signal.

The switching supply circuit 50 may also include other feedback signals to regulate the output current I_{L}. Accordingly, the switching supply circuit 50 may also include a comparator 90. The comparator 90 receives the output voltage V_{OUT} of the switching supply circuit 50 as an input to a positive terminal, and a preset voltage V_{REF} as an input to a negative terminal. The comparator 90 has an output terminal that is input as a feedback signal to the driver control circuit 52, such that the driver control circuit 52 has a redundant feedback to regulate the output current I_{L} of the switching supply circuit 50. In the example of FIG. 2, the comparator 90 monitors the output voltage V_{OUT} by comparing it to the preset voltage V_{REF}. While the output voltage V_{OUT} has a voltage potential that is greater than the preset voltage V_{REF}, the comparator 90 outputs a high digital signal (e.g., logic 1) to the driver control circuit 52, indicating to the driver control circuit 52 that the output voltage V_{OUT} is at an acceptably high voltage potential. If the output voltage V_{OUT} drops below the preset voltage V_{REF}, the comparator 90 outputs a low digital signal (e.g., logic 0) to the driver control circuit 52, thus indicating to the driver control circuit 52 that the output voltage V_{OUT} has decreased to an unacceptable operating level. The driver control circuit 52 could thus compensate by, for example, increasing the switching frequency of the high-side FET 54. The feedback from the comparator 90, combined with the simulated output signal, could thus provide for a more accurate feedback for regulating the output current I_{L} of the switching supply circuit 50.

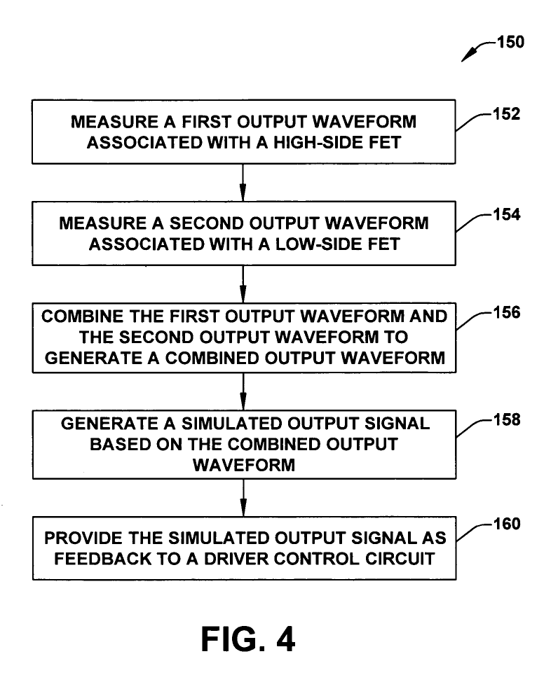

In view of the foregoing structural and functional features described above, certain methods will be better appreciated with reference to FIG. 4. It is to be understood and appreciated that the illustrated actions, in other embodiments, may occur in different orders and/or concurrently with other actions. Moreover, not all illustrated features may be required to implement a method.

FIG. 4 demonstrates a method 150 for regulating an output current in a switching supply circuit in accordance with an aspect of the invention. At 152, a first output waveform associated with a high-side FET is measured. The first output waveform could be a voltage waveform associated with activation and deactivation of the high-side FET. The first output waveform could be measured by measuring current flow through a sense resistor that is arranged parallel to the high-side FET. At 154, a second output waveform associated with a low-side FET is measured. The second output waveform could be a voltage waveform associated with activation and deactivation of the low-side FET. The second output waveform could be measured by measuring current flow through a sense resistor that is arranged parallel to the low-side FET. At 156, the first output waveform and the second output waveform are combined to generate a combined output waveform. The first output waveform and the second output waveform could be combined by an analog multiplexer that outputs the combined output waveform. At 158, a simulated output signal is generated based on the combined output waveform. The simulated output waveform is a substantial representation of an output current of the switching supply circuit. The simulated output waveform could be a current waveform or a voltage waveform. The simulated output waveform could be generated by removing switching gaps from a combined voltage waveform, and the resultant signal could be converted to a current signal. At 160, the simulated output signal is provided as a feedback signal to a driver control circuit to regulate the output current of the switching supply circuit. The driver control circuit could use the feedback signal, for example, to adjust the duty cycle of the switching of the high-side FET and the low-side FET.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A switching supply circuit comprising:
a high-side field-effect transistor (FET);
a low-side FET;
a driver control circuit operative to switch the high-side FET and the low-side FET between opposing “ON” and “OFF” states; and
a simulated output generator operative to combine both a first output waveform associated with the high-side FET and a second output waveform associated with the low-side FET to generate a simulated output signal that is a substantial representation of an output signal of the switching supply circuit, the simulated output signal being provided as a feedback to the driver control circuit.

2. The switching supply circuit of claim 1, further comprising:
a first sense circuit connected in parallel with the high-side FET, the first sense circuit being operative to measure a current flow through the high-side FET to provide the first output waveform; and
a second sense circuit connected in parallel with the low-side FET, the second sense circuit being operative to measure a current flow through the low-side FET to provide the second output waveform.

3. The switching supply circuit of claim 2, wherein the first sense circuit comprises a first transistor and a first resistor connected in series, the first resistor being operative to measure a current flow associated with the high-side FET, and wherein the second sense circuit comprises a second transistor and a second resistor connected in series, the second resistor being operative to measure a current flow associated with the low-side FET.

4. The switching supply circuit of claim 3, wherein the first transistor is substantially smaller than the high-side FET and the second transistor is substantially smaller than the low-side FET, and wherein the first transistor and the high-side FET have a ratio in size that is substantially equal to a ratio in size between the second transistor and the low-side FET.

5. The switching supply circuit of claim 3, wherein the first sense circuit further comprises a first voltage converter circuit operative to convert a current flow through the first sense resistor into the first output waveform, and wherein the second sense circuit further comprises a second voltage converter circuit operative to convert a current flow through the second sense resistor into the second output waveform.

6. The switching supply circuit of claim 1, wherein the simulated output generator comprises an analog multiplexer operative to combine the first output waveform and the second output waveform to provide a combined voltage waveform that is substantially similar to the simulated output signal.

7. The switching supply circuit of claim 1, wherein the switching supply circuit is one of a buck converter and a boost converter.

8. The switching supply circuit of claim 1, wherein the switching supply circuit is of a fixed-frequency pulse-width modulation regulator and a self-oscillating pulse-width modulation regulator.

9. The switching supply circuit of claim 1, further comprising an output inductor, and wherein the simulated output signal is a substantial representation of a regulator output current associated with the output inductor.

10. The switching supply circuit of claim 9, further comprising a comparator operative to compare a voltage potential associated with the output of the switching supply circuit with a preset voltage, and further operative to provide a digital output as a second feedback to the driver control circuit, the digital signal indicating the voltage potential of the output of the switching supply circuit relative to the preset voltage.

11. The switching supply circuit of claim 1, wherein the simulated output generator further comprises a track-and-hold circuit for removing switching gaps from the combined first output waveform and second output waveform to create the simulated output signal.

12. A method for regulating an output current in a switching supply circuit, the method comprising:
measuring a first output waveform associated with a high-side field-effect transistor (FET);
measuring a second output waveform associated with a low-side FET;
combining the first output waveform and the second output waveform to generate a combined output waveform;
generating a simulated output signal based on the combined output waveform, the simulated output signal being a substantial representation of the output current of the switching supply circuit; and
providing the simulated output signal as a feedback to a driver control circuit.

13. The method of claim 12, further comprising removing switching gaps from the combined voltage waveform to generate the simulated output signal.

14. The method of claim 12, further comprising converting the simulated output signal to a simulated output current signal, and providing the simulated output current signal as feedback to the driver control circuit.

15. The method of claim 12, wherein the measuring the first output waveform comprises measuring a current flow through a first sense resistor, the first sense resistor arranged parallel to the high-side FET, and converting the measured current through the first sense resistor into the first output waveform, and wherein the measuring the second output waveform comprises measuring a current flow through a second sense resistor, the second sense resistor arranged parallel to the low-side FET, and converting the measured current through the second sense resistor into the second output waveform.

16. The method of claim 12, further comprising multiplexing the first output waveform and the second output waveform to generate the combined output waveform.

17. The method of claim 12, further comprising:
measuring an output voltage of the switching supply circuit;
comparing the measured output voltage with a preset voltage; and
providing a digital signal as a second feedback to the driver control circuit, the digital signal indicating the voltage potential of the output voltage relative to the preset voltage.

18. A switching supply circuit comprising:
means for a measuring a first output signal associated with a high-side field-effect transistor (FET);
means for a measuring a second output signal associated with a low-side FET;
means for combining the first output signal and the second output signal to generate a simulated output signal, the simulated output signal being a substantial representation of the output of the switching supply circuit; and
means for regulating the output of the switching supply circuit based on the simulated output signal.

19. The switching supply circuit of claim 18, further comprising means for removing switching gaps from the combined first output signal and second output signal to generate the simulated output signal.

20. The switching supply circuit of claim 18, further comprising means for converting the simulated output signal to an approximation of a current flow through an output inductor that is connected at the output of the switching supply circuit.

21. The switching supply circuit of claim 18, further comprising means for measuring an output voltage potential of the switching supply circuit and means for regulating the output of the switching supply circuit based additionally on the measured output voltage potential of the switching supply circuit.
